(19) United States
(12) Patent Application Publication
(10) Pub. No.: US 2009/0179746 A1
(43) Pub. Date: Jul. 16, 2009

(54) BURGLAR-PROOF GPS VEHICLE TERMINAL WITH FUNCTIONS OF INDEPENDENT MONITORING AND RESETTING

(76) Inventor: Ming-Cheng HSIANG, Taipei (TW)

Correspondence Address: Ming-Cheng HSIANG, 235 Chung - Ho Box 8-24, Taipei, TW

(21) Appl. No.: 11/971,915

(22) Filed: Jan. 10, 2008

(51) Int. Cl. B60R 25/10

(52) U.S. Cl. 340/426.1

(57) ABSTRACT

A burglar-proof GPS vehicle terminal with functions of independent monitoring and resetting uses a phone book function of the SIM card without needing any input interface. A built-in ball vibration sensor is used to determine whether the vehicle owner is within the vehicle. The terminal entering into a power saving mode automatically and entering into a burglar proof mode according to the setting of parameters. The GPS vehicle terminal has functions of independent monitoring and resetting satellite positioning and receiving module, the microprocessor, the burglar proof interface, and the mobile communication module. A reset control switch serves to control the reset function so that when the external power source or internal power source is turned off, they can restore automatically.

### FIELD OF THE INVENTION

The present invention relates to GPS (global positioning systems), and particularly to a burglar-proof GPS vehicle terminal with functions of independent monitoring and resetting which uses a phone book function of the SIM card without needing any input interface. A built-in ball vibration sensor is used to determine whether the vehicle owner is within the vehicle. The terminal entering into a power saving mode automatically and entering into a burglar proof mode according to the setting of parameters. The GPS vehicle terminal has functions of independent monitoring and resetting satellite positioning and receiving module, the microprocessor, the burglar proof interface, and the mobile communication module. A reset control switch serves to control the reset function so that when the external power source or internal power source is turned off, they can restore automatically.

### BACKGROUND OF THE INVENTION

The current burglar proof technology is improved from mechanic locks into GPS system, but it still has many defects. In the prior art, the program built-in is burnt therein. It is very difficult to amend the program in installation. A dialing device can be used in amendment, but more hardware interfaces are necessary (such as infrared dialing devices, and infrared receivers), even a speech IC is necessary so that the hardware equipment is more complicated and cost is also increased. Furthermore, in some application, the EEPROM (electronic erasable programming ROM) is detached. Although it can be used repeatedly and can be carried out conveniently, it is different to amend the content thereof. Once a mainframe is necessary to be updated, all setting must be reset. It is very inconvenient. Furthermore, no detecting point for auto-detection of the engine induces that many informing system can not charged or cannot enter into power saving mode. Moreover, the prior art design is based on the detection points of the engine auto-detection (ACC) of the engine. If in installation, the points are not found, it is possible that the power is not sufficient charged or power is over-consumed. In the prior art some burglar proof devices are based on the door switches, in-car lights, or switches of the engine cover. However in many newly designed cars, these detection points can not be found and thus it is difficult in burglar proof. Other then general car, the prior art detectors are not water-proof, and thus they are not suitable to be installed in boats, and other working used vehicles. In the prior art, the program must be inputted to the mainframe before leaving the manufacturing plants and it can not be modified by the user. The manufacturing work is inconvenient and there are many different types. Furthermore, current processors are built in with the function of watchdog to prevent the program from interruption. However it is often that the program is too big to awake the function of watchdog.

### SUMMARY OF THE INVENTION

Accordingly, the object of the present invention is to provide a GPS vehicle terminal with functions of independent monitoring and resetting which uses the phone book function of the SIM card without needing any input interface. A built-in ball vibration sensor is used to determine whether the vehicle owner is within the vehicle; the terminal entering into a power saving mode automatically and entering into a burglar proof mode according to the setting of parameters. The GPS vehicle terminal with functions of independent monitoring and resetting of the satellite positioning and receiving module, the microprocessor, the burglar proof interface, and the mobile communication module. A reset control switch serves to control the reset function so that when the external power source or internal power source is turned off, they can restore automatically. To achieve above object, the present invention provides a GPS vehicle terminal with functions of independent monitoring and resetting, comprising: a remote controller for emitting wireless signals; a receiving interface for receiving signals from the remote controller; a microprocessor unidirectionally connected to the receiving interface for controlling all digital inputs and digital outputs; a mobile communication module bidirectionally connected to the microprocessor for inputting detection signals; a mobile communication module bidirectionally connected to the microprocessor for connecting to a phone or a receiving or transmitting short messages; an SIM card bidirectionally connected to the mobile communication module for storing and modifying all parameter and instructions by using a phone book function of the SIM card; a talk interface unidirectionally connected to the mobile communication module for talking with a far end person or monitoring a status of the vehicle; a satellite positioning and receiving module unidirectionally connected to the microprocessor for receiving satellite positioning signals and converting the satellite positioning signals into positioning coordinates which are then transferred to the microprocessor by data strings; an independent monitoring and reset device unidirectionally connected to the satellite positioning and receiving module, the microprocessor, the burglar proof interface, and the mobile communication module for monitoring the satellite positioning and receiving module, the microprocessor, the burglar proof interface and the mobile communication module; and a reset control switch unidirectionally connected to the independent monitoring and reset device for controlling the reset function so that when an external power source or an internal power source is turned off, they can be restored.

The various objects and advantages of the present invention will be more readily understood from the following detailed description when read in conjunction with the appended drawing.

### BRIEF DESCRIPTION OF THE DRAWINGS

FIG. 1 shows the circuit block diagram of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

Referring to the appended drawings, the system of the present inventions will be described with reference to the drawings. The present is related to a burglar proof system which is installed to a car for burglar proof.

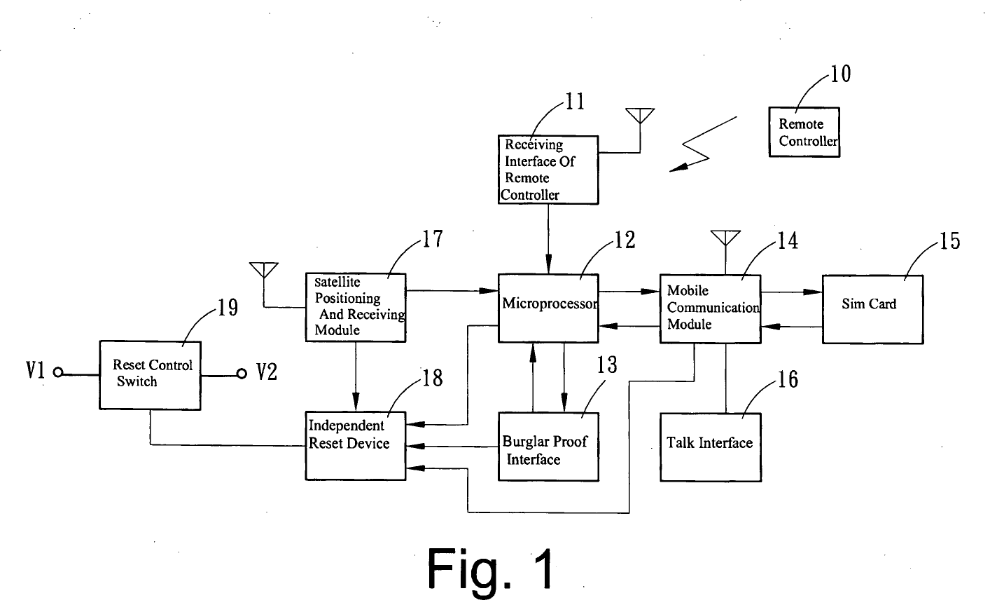

Referring to FIG. 1, the present invention mainly has a remote controller 10 which can emit wireless signals by using encoding and modulating technologies to input data in high frequency electronic waves. Generally, there are four keys, it can be expanded to 14 keys, such as an SOS rescue key, a burglar proof key, a burglar proof release key, and a test key. Four more keys can be installed, for example a designate talking key 1, another designate talking key 2, a joint key and a pause key. A receiving interface 11 of the remote controller 10 serves for receiving the wireless signals from the remote controller 10 and then returns the received signals. The receiving interface 11 has a four bit string, where all 0s and all 1s are not used, and thus there are 14 sets being used. A microprocessor 12 is unidirectionally connected to the receiving interface 11 of the remote controller 10 for controlling all digital inputs and all digital outputs. An analog to digital converter is installed in the microprocessor 12 for determining a main voltage for power so as to determine whether an engine is actuated by the difference of the voltages and thus the wiring in installation can be reduced and as a reference when a power saving mode is actuated. A burglar proof interface 13 is bidirectionally connected to the microprocessor 12 for inputting detection signals. The burglar proof interface 13 is installed with a microwave sensor, a micro sensor, a sensor for sensing the towing-away of a vehicle, a supersonic sensor, a wireless transmitter, a ball-type vibration sensor for determining whether the owner of the vehicle is in the vehicle so as to enter into a power saving mode or enter into a burglar proof mode according to the default setting. A mobile communication module 14 is bidirectionally connected to the microprocessor 12 for switching the operation mode from a talking mode to a short message transmission mode by AT instructions. An SIM card 15 is bidirectionally connected to the mobile communication module 14 for storing parameters and instructions by the function of a phone book and the SIM card 15 has a buckling seat with six legs. If the GPS terminal is abnormal and is necessary to be updated, it is only necessary to move the SIM card 15 to the new GPS terminal. A talk interface 16 is unidirectionally connected to the mobile communication module 14 for talking to a person at a far end or monitoring. The talk interface 16 is installed with a trumpet and a microphone. A satellite positioning and receiving module 17 is unidirectionally connected to the microprocessor 12 for converting received satellite positioning signals into a current coordinate and then the coordinate is transferred to the microprocessor 12 with a form of a data string. An independent monitoring and reset device 18 is unidirectionally connected to the satellite positioning and receiving module 17, the microprocessor 12, the burglar proof interface 13, and the mobile communication module 14 for monitoring the signals of the satellite positioning and receiving module 17, the microprocessor 12, the burglar proof interface 13, the mobile communication module 14. When one of them is over the preset time, then a reset action is performed. A reset control switch 19 is unidirectionally connected to the independent reset device 18 for controlling the reset operation so that the external power source V1 and the internal power source V2 can be turn off and then restored.

Advantages of the present invention will be described herein.

The SIM card 15 has the function of phone book, which stores related parameters and various instructions. Because the phone book of the SIM card 15 is equipped in every handset, no further interface is necessary.

A built-in ball vibration sensor can determine that the car is motionless if no signal is received over 3 minutes. If the owner of the car is not in the car, it will enter into a power saving mode or enter into a burglar proof mode automatically.

Moreover, the burglar proof interface is installed with a microwave sensor for determining whether anyone invades into the vehicle by the variation of the microwave; a micro-vibration sensor as an assisting device as the microwave sensor has faults (in that the micro-vibration sensor is connected to the vibration sensor and is adjusted to have maximum sensitivity); a towing-sensor (general towing sensors use the inclination of the vehicles and are expensive, in the present invention, it is performed by adjusting the vibration sensor to have a lower sensitivity so that only great vibrations of the vehicle can be detected); a supersonic sensor for determining whether an invader enters into the vehicle by the reflection time of the supersonic wave; a wireless sensor emitter which is connected to a lock. When the lock engaging with the steering wheel is destroyed, it is triggered to emit signals. In above inputs for burglar proof, the trigger signals can be re-actuated with different time periods so as to inform the owner of the car and the monitoring center for further processing.

The present invention has a stand type and a transversal type and the welding portions are sealed by electric tapes so as to have the effect of waterproof.

The present invention can be installed easily. The vibration sensor of the present invention is only necessary to be connected to the main power source (or ACC) by connecting two wires. The parameters can be set to be reset after three minutes from stop and then the vibration trigger is actuated.

The present invention can be performed with pure GPS alert system, or with persons in monitor center, or equipped with personal computers or a PDA monitoring.

The GPS vehicle terminal with functions of independent monitoring and resetting monitors the satellite positioning and receiving module, the microprocessor, the burglar proof interface, and the mobile communication module. A reset control switch serves to control the reset function so that when the external power source or internal power source is turned off, they can restore automatically.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A burglar-proof GPS vehicle terminal with functions of independent monitoring and resetting comprising:
a remote controller for emitting wireless signals;
a receiving interface for receiving signals from the remote controller;
a microprocessor unidirectionally connected to the receiving interface for controlling all digital inputs and digital outputs;
a mobile communication module bidirectionally connected to the microprocessor for inputting detection signals;
a mobile communication module bidirectionally connected to the microprocessor for connecting to a phone or a receiving or transmitting short messages;
an SIM card bidirectionally connected to the mobile communication module for storing and modifying all parameter and instructions by using a phone book function of the SIM card; a talk interface unidirectionally connected to the mobile communication module for talking with a far end person or monitoring a status of the vehicle;
a satellite positioning and receiving module unidirectionally connected to the microprocessor for receiving satellite positioning signals and converting the satellite positioning signals into positioning coordinates which are then transferred to the microprocessor by data strings;
an independent monitoring and reset device unidirectionally connected to the satellite positioning and receiving module, the microprocessor, the burglar proof interface, and the mobile communication module for monitoring the satellite positioning and receiving module, the microprocessor, the burglar proof interface and the mobile communication module; and
a reset control switch unidirectionally connected to the independent monitoring and reset device for controlling the reset function so that when an external power source or an internal power source is turned off, they can be restored.

2. The burglar-proof GPS vehicle terminal with functions of independent monitoring and resetting as claimed in claim 1, wherein the a remote controller emits wireless signals by using encoding and modulating technologies to input data in high frequency electronic waves; the remote controller has at least four keys.

3. The burglar-proof GPS vehicle terminal with functions of independent monitoring and resetting as claimed in claim 2, wherein a number of the key is expanded to 14 keys including an SOS rescue key, a burglar proof key, a burglar proof release key, a test key, a first designate talking key, a second designate talking key, a joint key and a pause key.

4. The burglar-proof GPS vehicle terminal with functions of independent monitoring and resetting as claimed in claim 1, wherein the receiving interface uses four bit strings, where all 0 and all 1 are not used, and thus there are 14 sets of bit strings being used.

5. The burglar-proof GPS vehicle terminal with functions of independent monitoring and resetting as claimed in claim 1, wherein the burglar proof interface includes a microwave sensor, a micro-vibration sensor, a tow-away sensor, a supersonic sensor, and a wireless sensor transmitter.

6. The burglar-proof GPS vehicle terminal with functions of independent monitoring and resetting as claimed in claim 1, wherein the SIM card has a buckling seat with six legs; when it is desired to update the terminal, it is only necessary to move the SIM card to a new terminal.

7. The burglar-proof GPS vehicle terminal with functions of independent monitoring and resetting as claimed in claim 1, wherein the talk interface has a trumpet and a microphone.

8. The burglar-proof GPS vehicle terminal with functions of independent monitoring and resetting as claimed in claim 1, wherein the independent monitoring and reset device monitors signals of the satellite positioning and receiving module, the microprocessor, and the mobile communication module; when one of them is abnormal, a reset operation is performed.

9. The burglar-proof GPS vehicle terminal with functions of independent monitoring and resetting as claimed in claim 1, wherein an analog to digital converter is installed in the microprocessor for determining a voltage of main power so as to determine whether an engine is actuated by differences of the voltages and thus wiring in installation is reduced and as a reference when it is input a power saving mode.
